(19) United States
(12) Patent Application Publication
(10) Pub. No.: US 2023/0075588 A1
(43) Pub. Date: Mar. 9, 2023

(54) SYSTEM FOR MANAGEMENT OF DISTRIBUTION ACCORDING TO A DYNAMIC RANKING OF RECEIVING ENTITIES

(71) Applicant: Capital One Services, LLC, McLean, VA (US)

(72) Inventors: Lin Ni Lisa CHENG, New York, NY (US); Vyjayanthi VADREVU, Pflugerville, TX (US); Xiaoguang ZHU, New York, NY (US)

(21) Appl. No.: 17/445,900

(22) Filed: Aug. 25, 2021

(51) Int. Cl. G06Q 30/02; G06Q 10/06

(52) U.S. Cl. CPC G06Q 30/0279; G06Q 30/0204; G06Q 10/06315

(57) ABSTRACT

In some implementations, a system may receive a distribution request that is associated with a user account and an entity category. The system may identify a set of receiving entities associated with the entity category. The individual entities of the receiving entities may be approved to receive distributions associated with user accounts of the service provider. The system may determine, according to impact scores for the set of receiving entities, a ranking of the set of receiving entities according to respective information associated with individual entities of the set of receiving entities. The system may select, from the set of receiving entities and according to the ranking, a receiving entity from the set of receiving entities to receive the distribution as indicated in the distribution request. The system may facilitate a transfer of the distribution from the user account to the receiving entity.

### BACKGROUND

A charitable organization is an entity with a primary object of philanthropy and social well-being. Various categories of charitable organizations may exist according to individual causes of the charitable organizations. In some instances, a malicious entity may claim to be a charitable organization to fraudulently receive donations via distributions (or transfers of funds) from donors that are scammed into believing that the distributions are not being contributed to a charitable cause.

### SUMMARY

Some implementations described herein relate to a system for managing a distribution associated with a service provider. The system may include one or more memories and one or more processors communicatively coupled to the one or more memories. The one or more processors may be configured to receive a distribution request that is associated with a user account and an entity category. The one or more processors may be configured to identify a set of receiving entities associated with the entity category. The one or more processors may be configured to determine, according to impact scores for the set of receiving entities, a ranking of the set of receiving entities according to respective information associated with individual entities of the set of receiving entities. The one or more processors may be configured to select, from the set of receiving entities and according to the ranking, a receiving entity from the set of receiving entities to receive the distribution as indicated in the distribution request. The one or more processors may be configured to facilitate a transfer of the distribution from the user account to the receiving entity.

Some implementations described herein relate to a non-transitory computer-readable medium that stores a set of instructions for a device. The set of instructions, when executed by one or more processors of the device, may cause the device to receive an approval request that is associated with an entity being authorized to receive distributions associated with user accounts of a service provider. The set of instructions, when executed by one or more processors of the device, may cause the device to receive, from an external information source, external information associated with the entity. The set of instructions, when executed by one or more processors of the device, may cause the device to designate, based on processing the internal information and the external information, the entity to be approved as one of a set of receiving entities associated with the entity category. The set of instructions, when executed by one or more processors of the device, may cause the device to determine, based on the internal information and the external information, an impact score associated with the entity being approved. The set of instructions, when executed by one or more processors of the device, may cause the device to rank, based on the impact score, the entity within a ranking of the set of receiving entities. The set of instructions, when executed by one or more processors of the device, may cause the device to perform an action associated with facilitating a transfer of a distribution from a user account to the receiving entity based on the ranking.

Some implementations described herein relate to a method for managing a distribution associated with a service provider. The method may include receiving, by a device, a point distribution request that is associated with a user account and an entity category. The method may include identifying, by the device, a set of receiving entities associated with the entity category, where individual entities of the receiving entities are approved to receive distributions associated with user accounts of the service provider. The method may include selecting, by the device and according to a ranking of the set of receiving entities, a receiving entity from the set of receiving entities. The method may include determining, by the device and from the point distribution request, that a distribution is designated for redemption with a particular type of merchant. The method may include configuring, by the device, the distribution for redemption via the particular type of merchant to generate a restricted distribution. The method may include facilitating, by the device, a transfer of the restricted distribution from a point balance of the user account to a redemption balance of the receiving entity.

### BRIEF DESCRIPTION OF THE DRAWINGS

FIGS. 1A-1B are diagrams of an example implementation relating to managing a distribution according to a dynamic ranking of receiving entities.

FIG. 2 is a diagram of an example implementation associated with management of a distribution according to a dynamic ranking of receiving entities.

FIG. 3 is a diagram of an example environment in which systems and/or methods described herein may be implemented.

FIG. 4 is a diagram of example components of one or more devices of FIG. 3.

FIG. 5 is a flowchart of an example process associated with management of a distribution according to a dynamic ranking of receiving entities.

### DETAILED DESCRIPTION

The following detailed description of example implementations refers to the accompanying drawings. The same reference numbers in different drawings may identify the same or similar elements.

Charitable organizations typically are developed and operated in order to advance a cause, advance research, address a social issue, address an environmental issue, and/or contribute to other philanthropic causes. As a quantity of charitable organizations increases, a new charitable organization is typically faced with challenges of gaining exposure in a particular charitable category, which can result in an inability to raise sufficient funds to operate and/or to impact a cause of the new charitable organization. Conversely, as the quantity of charitable organizations increases, a donor is faced with challenges involved with identifying new charitable organizations that may be of interest to the donor and/or ensuring that certain charitable organizations are effectively and efficiently operating to advance a cause that is important to the donor. Moreover, a donor that decides to provide a distribution to a charitable organization may not be able to ensure that the charitable organization uses the distribution in a particular manner that advances a cause that is important to the donor. Due to the quantity of charitable organizations, quantity of information sources that provide information about the charitable organizations, and/or reliability of the charitable organizations and/or information sources, and constantly changing conditions of the charitable organizations, detection and/or validation of reputable and/or impactful charitable organizations can be relatively complex and/or relatively high amounts of resources (e.g., computing resources for researching and/or validating charitable organizations).

Some implementations described herein provide a distribution management system that dynamically ranks receiving entities (e.g., charitable organizations and/or other types of non-profit organizations) according to monitored information associated with the receiving entities. Furthermore, the distribution management system, as described herein, may enable a user of a user account associated with the distribution management system to designate distributions to go to one or more categories according to a ranking of the receiving entities. In this way, the distribution management system can instill confidence in the user that a distribution from the user is to be received by a reputable receiving entity that is trustworthy and having a strong impact on a cause that is of interest to the user (e.g., a strongest impact relative to other receiving entities associated with a same category as the receiving entity). Moreover, the distribution management system may be configured to detect receiving entities that have a relatively low impact on a particular cause (e.g., due to poor performance, poor operability, and/or dishonest practices) and/or that are fraudulently claiming to be charitable organizations. In this way, the distribution management system may prevent wasteful distributions to ineffective receiving entities and/or may prevent fraud and/or fraudulent transactions associated with donations to the fraudulent organizations.

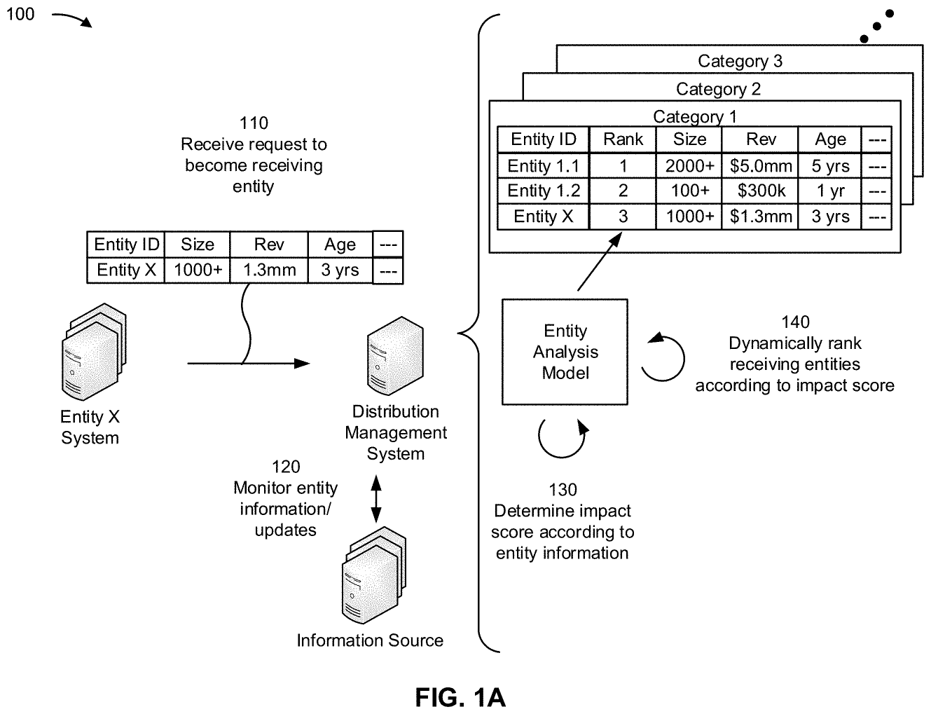

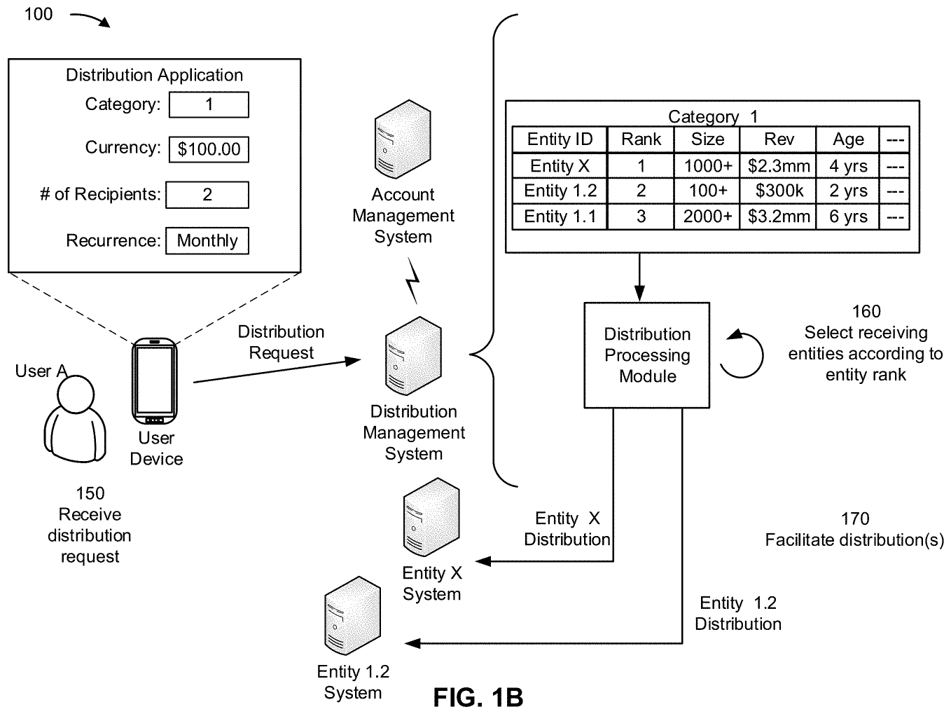

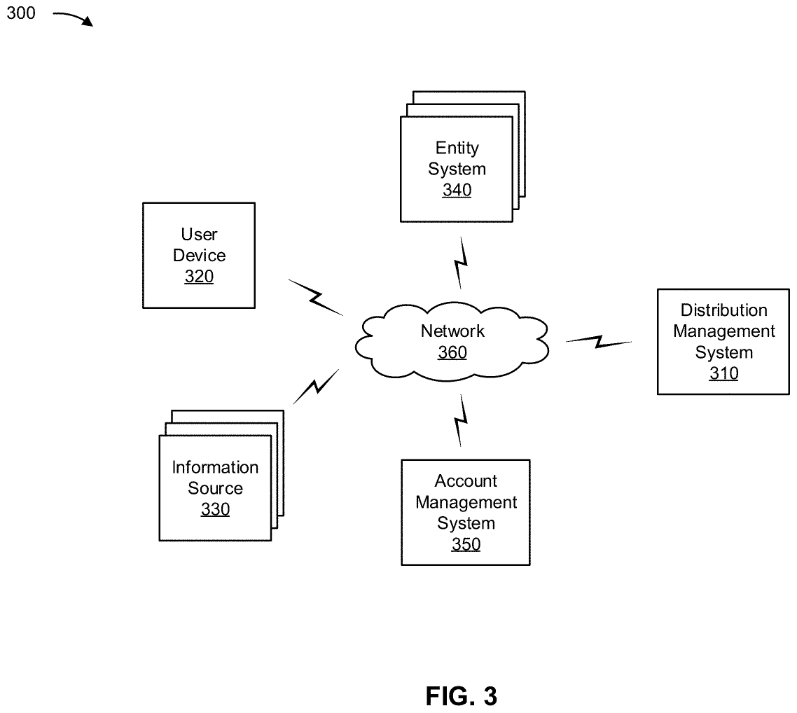

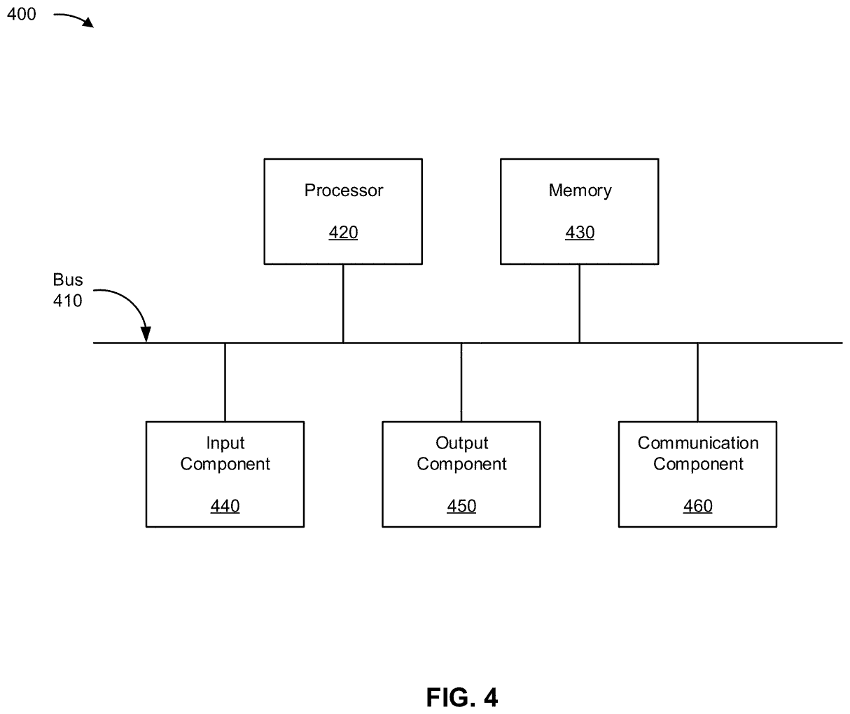

FIGS. 1A-1B are diagrams of an example implementation 100 relating to managing a distribution according to a dynamic ranking of receiving entities. Example implementation 100 includes a distribution management system, an entity system (Entity X System), one or more information sources, a user device a user (User A), and an account management system. These devices are further described below, at least in connection with FIG. 3 and FIG. 4.

In example implementation 100, the distribution management system and/or the account management system may be associated with a service provider (e.g., a financial institution, a merchant, or the like) that is configured to manage a distribution for one or more users associated with user accounts that are managed by the account management system. The user accounts may include one or more of a transaction account (e.g., a financial account, such as a checking account and/or a credit account) and/or a membership account (e.g., an account that enable users to accrue benefits via a point system that utilizes points (e.g. rewards points or loyalty points) in association with a rewards program or a loyalty program). The information sources may correspond to external (or third party) information sources, such as news outlets, websites, blogs, governmental agencies, or other types of external information sources that are capable of providing publicly available information or reports associated with receiving entities described herein.

As shown in FIG. 1A, and by reference number 110, the distribution management system receives a request for an entity to become a receiving entity. The request may correspond to an approval request from an entity (e.g., a new entity associated with an entity category) that is seeking to qualify as a receiving entity of the distribution management system. Accordingly, the entity may request to be authorized to receive distributions associated with user accounts of the service provider.

The request may include an entity identifier (Entity ID) and one or more characteristics of the entity. The one or more characteristics may correspond to internal information that is associated with and/or provided by the entity. In some implementations, the internal information includes information may not be publicly available (e.g., may not be available to any of the information sources). For example, as shown in FIG. 1A, the request may include a size characteristic (Size), a revenue characteristic (Rev), and an age characteristic (Age). Accordingly, the entity may indicate, within the request that the entity is identified by Entity X, has a size of 1000+, has revenue (Rev) of $1.3 million, and has an age of 3 years. Additionally, or alternatively, the request may include an entity category associated with the entity (e.g., a category that is indicative of a cause associated with the entity, such as a charitable cause and/or philanthropic cause).

As further shown in FIG. 1A, and by reference number 120, the distribution management system monitors entity information and/or updates. For example, the distribution management system may receive external information associated with the entity. The distribution management system may receive the external information based on requesting the information sources to provide any external information associated with the entity (e.g., news articles, media, blog posts, or the like) that is independently stored and/or managed by the information sources (e.g., separately from the entity or the service provider).

As further shown in FIG. 1A, and by reference number 130, the distribution management system may determine an impact score associated with entity. The distribution management system may designate the entity to be approved a set of receiving entities that are associated with an entity category.

The distribution management system may determine the impact score based on the internal information from the request or external information obtained from one or more of the information sources. For example, the distribution management system may process the internal information and/or the external information using a natural language processing technique (e.g., to determine a status of the entity or verify one or more of the characteristics of the entity) and/or a sentiment analysis technique (e.g., to determine a sentiment toward the entity in a piece of information and/or whether the entity is portrayed as having a positive impact on a cause associated with an entity category of the entity).

In some implementations, the distribution management system can utilize a scoring system to determine an impact score associated with an impact that the entity has on a cause associated with the entity category of the entity. The distribution management system may determine the impact score based on characteristics of the entity and/or characteristics of the other receiving entities associated with the entity category. Using such a scoring system, the distribution management system can apply weights (w) to parameters corresponding to the one or more parameters of the receiving entities that can be identified from processing the internal information and/or the external information. Such characteristics may include a size of an entity, an annual revenue (or profit) of the entity, an age of the entity, a measure of positive impact of the entity (e.g., based on detected positive sentiment) and/or timing of the measure of positive impact, a measure of negative impact of the entity (e.g., based on detected negative sentiment) and/or timing associated with the measure of negative impact. Accordingly, the distribution management system can determine (e.g., via one or more calculations associated with the scoring system) scores for a set of receiving entities based on the scoring system that are representative of the impact that the individual receiving entities have on a cause associated with an entity category of the set of receiving entities. For example, the distribution management system can use the following to determine the score (sᵢⱼ) based on three characteristics a, b, c of an entity i for an entity category j:

sᵢⱼ=wₐⱼaᵢ+w_{bj}bᵢ+w_{cj}cᵢ+ . . . (1)

where wₐⱼ, w_{bj}, w_{cj} corresponds to adjusted weights based on the relevance to the entity category j for parameters aᵢ, bᵢ, cᵢ that correspond to the characteristics of the entity i. For example, parameters aᵢ, bᵢ, cᵢ may include a value (e.g., a characteristic-specific score) associated with a scale for the respective characteristics associated with parameters aᵢ, bᵢ, cᵢ. Additionally, or alternatively, the adjusted weights wₐⱼ, w_{bj}, w_{cj} may be normalized (e.g., where 0≤wₐⱼ, w_{bj}, w_{cj}≤1 and wₐⱼ+w_{bj}+w_{cj}=1). In this way, the distribution management system may determine an impact score associated with one or more of the receiving entities to permit the distribution management system to rank the receiving entities according to the impact score. Furthermore, the corresponding impact scores for individual entities of a set of entities may be determined based on a weighted average of respective parameters associated with the set of receiving entities.

The distribution management system may designate, based on authentication and/or validation of the entities according to the impact scores (e.g., entities with impact scores that satisfy a threshold), entities as receiving entities. For example, the distribution management system may perform an authentication process to verify an identification of the entity (e.g., verify that Entity X is a valid entity identification and/or that an identity of a representative that provided the approval request is a valid individual identification). In some implementations, the distribution management system may validate and/or verify that parameters of the internal information conveyed by the entity matches (e.g., within a different threshold) corresponding parameters of external information received from the information sources (e.g., to verify truthfulness of the submitted internal information via a background check involving the information sources).

In this way, the distribution management system may designate and/or manage receiving entities that are approved to receive distributions associated with user accounts of the service provider.

As further shown in FIG. 1A, and by reference number 140, the distribution management system may dynamically rank the receiving entities according to impact scores. For example, based on one or more triggers (e.g., receiving an approval request from a new entity, receiving a distribution request from a user device, and/or the like), the distribution management system may update and/or determine a ranking of the set of receiving entities.

The distribution management system may determine a ranking of the set of receiving entities according to respective information (e.g., respective internal information and/or external information) associated with the individual entities of the set of receiving entities. The ranking may indicate that individual receiving entities of the set of receiving entities are ranked according to an impact that the individual receiving entities have on a cause associated with an entity category of the entities (e.g., which may be indicated by the corresponding impact scores of the individual receiving entities).

Accordingly, in example implementation 100, the distribution management system may rank Entity X, Entity 1.1, and Entity 1.2 based on received internal information and external information associated with Entity X, based on received internal information and external information associated with Entity 1.1, and received internal information and external information associated with Entity 1.2. As shown, the distribution management system may determine that Entity 1.1 is ranked 1^{st} (e.g., most impactful toward a cause of Category 1), Entity 1.2 is ranked 2^{nd} (e.g., second most impactful toward a cause of Category 1), and Entity X is ranked 3^{rd} (e.g., third most impactful toward a cause of Category 1).

As shown in FIG. 1B, and by reference number 150, the distribution management system may receive a distribution request from the user device. The distribution request may be received from the user via the distribution application and be associated with the user account and/or an entity category. The user may be a donor associated with an account of the distribution application. The entity category may be identified in the distribution request to indicate that one or more entities of the set of receiving entities are to receive the distribution.

In some implementations, the distribution request does not specifically identify a recipient entity that is to receive a distribution. For example, the distribution request may not specifically indicate that Entity X, Entity 1.1, or Entity 1.2 are to receive the distribution. However, as described herein, the distribution management system may manage a distribution to one or more entities without the distribution request specifically identifying the one or more entities. In this way, Entity X, Entity 1.1, or Entity 1.2 may receive a distribution based on a distribution request that does not specify Entity X, Entity 1.1, or Entity 1.2 (e.g., because the user may not know of or care which receiving entity receives the distribution, but only cares that the distribution is transferred to the most worthy or most impactful, relative to the designated set of receiving entities).

The distribution request may identify one or more characteristics of the distribution, such as a type of a transfer, a value of a distribution, a quantity of receiving entities to receive the distribution, and/or a frequency associated with facilitating transfers of the distribution. The may identify the one or more characteristics based on the application receiving one or more user inputs by the user. For example, the user inputs, as shown, may indicate (e.g., via corresponding fields) a category of a distribution associated with the distribution request (Category 1), a currency and/or a value of a currency of the distribution ($100,00), a quantity of recipients of the distribution (2), and a recurrence rate of the distribution (Monthly). As indicated by the currency value, the distribution request may be a monetary distribution request (or currency-based distribution request that involves a transfer of cash or a wire transfer).

In some implementations, one or more of the parameters of the distribution request may be recommended to the user. For example, the distribution application may be configured to recommend an entity category for a distribution. The distribution application may recommend the entity category based on learned, detected, or indicated interests of the user. For example, the distribution application may learn or detect a user's interest in a cause based on monitored user activity associated with the distribution application and/or user device (e.g., monitored online activity, monitored social media activity, previously requested distributions to receiving entities, or the like).

As further shown in FIG. 1B, and by reference number 160, the distribution management system may select the receiving entities according to the entity rank. For example, the distribution management system, based on the entity category of the distribution request, may the identify a set of receiving entities associated with the entity category. In example implementation 100, the set of receiving entities may include Entity X, Entity 1.1, and Entity 1.2.

In some implementations, prior to selecting the receiving entities, the distribution management system may rank (or re-rank) the receiving entities based on receiving the distribution request (e.g., so a selection of the receiving entities is made based on most recent available information associated with the receiving entities). In such a case, prior to determining the ranking, the distribution management system may receive (or retrieve) from the information source, external information associated with one or more of the receiving entities. Accordingly, as shown, after re-ranking the set of entities (e.g., based on newly obtained internal information or external information associated with the set of receiving entities), Entity X may be determined to be a most impactful receiving entity on a cause associated with Category 1, Entity 1.2 may be determined to be a second most impactful receiving entity on the cause, and Entity 1.1 may be determine to be a third most impactful receiving entity on the cause. In such a case, the newly obtained internal information or external information may indicate that Entity X had a relatively higher impact on the cause than Entity 1.1 during a time period that was between ranking the set of receiving entities above in association with the approval request from Entity X.

In this way, a receiving entity may be selected based on recently received external information that indicates a positive impact characteristic (e.g., a most recently determined or indicated positive impact as learned from the external information) associated with the receiving entity contributing to a cause of the entity category. The distribution management system may select, from the set of receiving entities and according to the ranking, a receiving entity from the set of receiving entities to receive the distribution as indicated in the distribution request. Accordingly, Entity X may be selected based on the ranking of Entity X indicating that Entity X is having (or has had) a greatest impact, relative to the set of receiving entities, on the cause associated with the Category 1.

Furthermore, because the distribution request indicates that two receiving entities are to receive a transfer associated with a distribution, the distribution management system may select a second receiving entity according to the ranking. Accordingly, in example implementation 100, the distribution management system may select Entity 1.2 to receive a transfer associated with the distribution. A share of the distribution between Entity 1.X and Entity 1.2 may distributed according to any suitable technique. For example, the distribution may be split evenly or according to a ratio (e.g., a ratio specified by the user). In this way, the user may request a distribution to be automatically distributed to two or more receiving entities (e.g., so that the user can diversify distributions to multiple receiving entities and/or share opportunities for the two receiving entities to increase respective impacts on a cause).

As further shown in FIG. 1B, and by reference number 170, the distribution management system may facilitate the distributions to the selected receiving entities. For example, the distribution management system may cause or coordinate with the account management system (via a transaction backend system of the account management system) to perform a transfer (e.g., a wire transfer, a debit transfer, a cash transfer) from an account of the user to an account of the entity. Accordingly, the distribution management system may facilitate a transfer of the distribution from the user account to the selected receiving entities.

In this way, the distribution management system may analyze, authenticate, and/or rank receiving entities in order to permit a distribution to one or more of the receiving entities to be quickly and efficiently processed without one or more of the receiving entities being specified in a distribution request associated with the distribution.

As indicated above, FIGS. 1A-1B are provided as an example. Other examples may differ from what is described with regard to FIGS. 1A-1B. The number and arrangement of devices shown in FIGS. 1A-1B are provided as an example. In practice, there may be additional devices, fewer devices, different devices, or differently arranged devices than those shown in FIGS. 1A-1B. Furthermore, two or more devices shown in FIGS. 1A-1B may be implemented within a single device, or a single device shown in FIGS. 1A-1B may be implemented as multiple, distributed devices. Additionally, or alternatively, a set of devices (e.g., one or more devices) shown in FIGS. 1A-1B may perform one or more functions described as being performed by another set of devices shown in FIGS. 1A-1B.

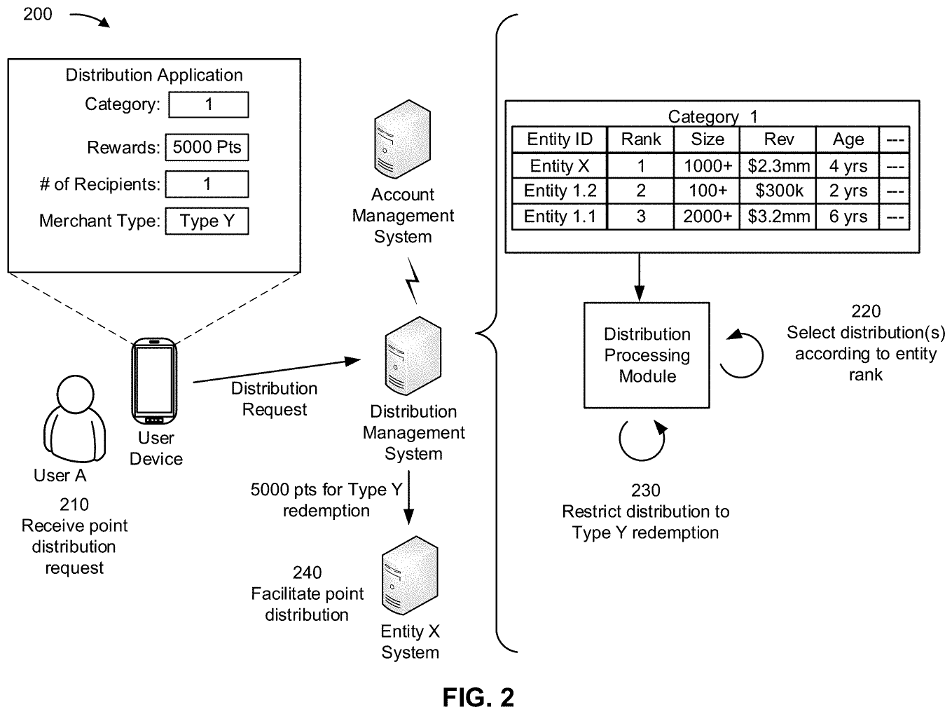

FIG. 2 is a diagram of an example implementation 200 associated with management of a distribution according to a dynamic ranking of receiving entities. Example implementation 200 includes a distribution management system, an entity system (Entity X System), a user device, and an account management system. These devices are further described below, at least in connection with FIG. 3 and FIG. 4.

As shown in FIG. 2, and by reference number 210, the distribution management system receives a point distribution request. Similar to the distribution request described in connection with example implementation 100, the point distribution request may be received via the distribution application (which may be associated with a membership account of the user and/or account management system). The point distribution request may not specify that one or more of the receiving entities are to receive the restricted distribution. The point distribution request may be associated with the user account and an entity category (e.g., the point distribution request may identify an entity category associated with one or more receiving entities that are to receive a transfer associated with a distribution as described herein). The point distribution request may be associated with a restricted distribution of points from a membership points balance associated with a user account (e.g., membership account of the user that is managed by the account management system). The point distribution request may be a restricted distribution request based on the point distribution request indicating that a redemption of points is restricted to a particular type of merchant or a particular type of transaction.

The point distribution request may be generated and/or received based on one or more user inputs from the user. For example, the user inputs, as shown, may indicate (e.g., via corresponding fields) a category of a point distribution associated with the point distribution request (Category 1), a rewards value of the restricted distribution (5000 points), a quantity of recipients of the restricted distribution (1), and a type of merchant (Type Y) that can be involved in a redemption of the point distribution. Additionally, or alternatively, the point distribution request may indicate a frequency associated with facilitating transfers of the restricted distribution.

As further shown in FIG. 2, and by reference number 220, the distribution management system may select the receiving entities according to the entity rank. For example, the distribution management system may select the receiving entities as described above in connection with example implementation 100. In example implementation 200, because the point distribution request designates a single entity to receive a point distribution, the distribution management system may select Entity X to receive the point distribution based on being the top ranked receiving entity according to the impact scores.

In some implementations, the distribution management system may select an entity based on whether the entity is associated with the account management system. For example, the distribution management system may select a top ranked entity that has an account registered with the account management system that may be required to redeem a point distribution. Accordingly, if Entity X does not have an account registered with the account management system, Entity X may be incapable of redeeming the point distribution, and the distribution management system may select the next highest ranked receiving entity, according to the impact scores, that has an account registered with the account management system (e.g., Entity 1.2)

As further shown in FIG. 2, and by reference number 230, the distribution management system may restrict a distribution to a Type Y redemption. For example, Type Y may be associated with a cause of Category 1. More specifically, if a cause of Category 1 involved building homes for the poor, Type Y may correspond to a merchant type that includes home improvement stores or hardware stores (e.g., because such stores sell materials that are needed to build homes for the poor). In this way, the user may ensure that points are redeemed to obtain materials that directly impact a cause of the entity category.

Based on the indicated restriction (e.g., the merchant type), the distribution management system may configure a distribution for redemption via the particular type of merchant (e.g., a type Y merchant) to generate the restricted distribution. For example, the distribution management system may append a token to a distribution (or a transfer of a distribution) to form the restricted distribution. The token may include any security mechanism that specifies a merchant identifier that is associated with the particular type of merchant. Furthermore, the token may be suitably configured to only allow a redemption of the restricted distribution that involves a merchant that is associated with the merchant identifier (e.g., a transaction involving the selected entity a merchant associated with the merchant identifier).

As further shown in FIG. 2, and by reference number 240, the distribution management system facilitates the point distribution. For example, the distribution management system may indicate, to the account management system, that a portion of a point balance of the user account is to be transferred to a redemption balance associated with the selected receiving entity. Additionally, or alternatively, the distribution management system may a transaction backend system associated with the account management system (and/or a service provider of the account management system) to reduce a point value identified in the point distribution request from the point balance of the user account. Furthermore, the distribution management system may cause the transaction backend system associated with the account management system to increase the redemption balance associated with an entity account of the receiving entity.

In this way, the transfer of the restricted distribution may include a membership point transfer from a membership point balance associated with the user account. Accordingly, for a transfer of a distribution, a user may restrict which types of redemptions can be performed, thereby being able to ensure that a distribution is more directly contributed to a particular cause via the restriction.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example environment 300 in which systems and/or methods described herein may be implemented. As shown in FIG. 3, environment 300 may include a distribution management system 310, a user device 320, an information source 330, an entity system 340, an account management system 350, and a network 360. Devices of environment 300 may interconnect via wired connections, wireless connections, or a combination of wired and wireless connections.

The distribution management system 310 includes one or more devices capable of receiving, generating, storing, processing, providing, and/or routing information associated with managing a distribution according to a dynamic ranking of receiving entities, as described elsewhere herein. The distribution management system 310 may include a communication device and/or a computing device. For example, the distribution management system 310 may include a server, such as an application server, a client server, a web server, a database server, a host server, a proxy server, a virtual server (e.g., executing on computing hardware), or a server in a cloud computing system. In some implementations, the distribution management system 310 includes computing hardware used in a cloud computing environment.

The user device 320 includes one or more devices capable of receiving, generating, storing, processing, and/or providing information associated with a distribution that is to be managed by distribution management system 310, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The information source 330 includes one or more devices capable of receiving, generating, storing, processing, and/or providing information associated with ranking receiving entities (e.g., entities associated with the entity systems 340) in association with receiving a distribution, as described elsewhere herein. The information source 330 may include a communication device and/or a computing device. For example, the information source 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The information source 330 may communicate (e.g., via a web page, a website, an RSS feed, and/or a media stream among other examples) with one or more other devices of environment 300, as described elsewhere herein.

The entity system 340 includes one or more devices capable of receiving, generating, storing, processing, providing, and/or routing information associated with entities that are to receive a distribution according to management of the distribution by the distribution management system 310, as described elsewhere herein. The entity system 340 may include a communication device and/or a computing device. For example, the entity system 340 may include a server, such as an application server, a client server, a web server, a database server, a host server, a proxy server, a virtual server (e.g., executing on computing hardware), or a server in a cloud computing system. In some implementations, the entity system 340 includes computing hardware used in a cloud computing environment.

The account management system 350 includes one or more devices capable of receiving, generating, storing, processing, providing, and/or routing information associated with managing an account of a user (e.g., a transaction account, a membership account associated with a merchant, or other type of account), as described elsewhere herein. The account management system 350 may include a communication device and/or a computing device. For example, the account management system 350 may include a server, such as an application server, a client server, a web server, a database server, a host server, a proxy server, a virtual server (e.g., executing on computing hardware), or a server in a cloud computing system. In some implementations, the account management system 350 includes computing hardware used in a cloud computing environment.

The account management system 350 may include and/or be associated with a transaction backend system that is capable of processing, authorizing, and/or facilitating a transaction, such as a transfer of a distribution from the account of the user to an entity associated with the entity system 340. For example, the account management system 350 may include or be associated with one or more servers and/or computing hardware of a transaction backend system that is (e.g., in a cloud computing environment or separate from a cloud computing environment) configured to receive and/or store information associated with processing an electronic transaction. The account management system 350, via the transaction backend system, may process a transaction, such as to approve (e.g., permit, authorize, or the like) or decline (e.g., reject, deny, or the like) the transaction and/or to complete the transaction if the transaction is approved. The account management system 350 may process the transaction based on information received from the user device 220, such as transaction data (e.g., information that identifies a transaction amount, a merchant, a time of a transaction, a location of the transaction, or the like), account information communicated to the user device 220 (e.g., account information associated with a transaction card and/or account information associated with a payment application) and/or information stored by the account management system 350 (e.g., for fraud detection).

The account management system 350 (and/or the transaction backend system) may be associated with a financial institution (e.g., a bank, a lender, a credit card company, or a credit union) and/or may be associated with a transaction card association that authorizes a transaction and/or facilitates a transfer of funds. For example, the account management system 350 may be associated with an issuing bank associated with the user account, an acquiring bank (or merchant bank) associated with the merchant and/or the transaction terminal, and/or a transaction card association (e.g., VISA® or MASTERCARD®) associated with a transaction card that is associated with the user account. Based on receiving information associated with the user account from the user device 220, one or more devices of the account management system 350 may communicate to authorize a transaction and/or to transfer funds from an account associated with the transaction device to an account of an entity (e.g., a merchant) associated with the transaction terminal.

The network 360 includes one or more wired and/or wireless networks. For example, the network 360 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 360 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the distribution management system 310, the user device 320, the information source 330, the entity system 340, and/or the account management system 350. In some implementations, the distribution management system 310, the user device 320, the information source 330, the entity system 340, and/or the account management system 350 may include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

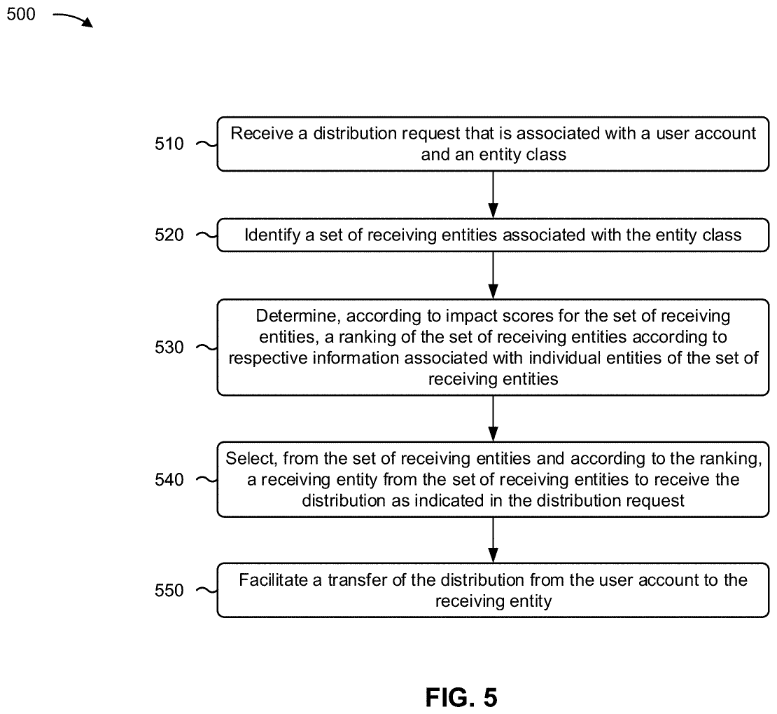

FIG. 5 is a flowchart of an example process 500 associated with management of distribution according to a dynamic ranking of receiving entities. In some implementations, one or more process blocks of FIG. 5 may be performed by a distribution management system (e.g., distribution management system 310). In some implementations, one or more process blocks of FIG. 5 may be performed by another device or a group of devices separate from or including the distribution management system, such as the user device 320, the information source 330, the entity system 340, and/or the account management system 350. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving a distribution request that is associated with a user account and an entity category (block 510). As further shown in FIG. 5, process 500 may include identifying a set of receiving entities associated with the entity category (block 520). The individual entities of the receiving entities may be approved to receive distributions associated with user accounts of the service provider.

As further shown in FIG. 5, process 500 may include determining, according to impact scores for the set of receiving entities, a ranking of the set of receiving entities according to respective information associated with individual entities of the set of receiving entities (block 530). The impact scores may be indicative of levels of impact of respective entities within the entity category.

As further shown in FIG. 5, process 500 may include selecting, from the set of receiving entities and according to the ranking, a receiving entity from the set of receiving entities to receive the distribution as indicated in the distribution request (block 540). As further shown in FIG. 5, process 500 may include facilitating a transfer of the distribution from the user account to the receiving entity (block 550).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for managing a distribution associated with a service provider, the system comprising:
one or more memories; and
one or more processors, communicatively coupled to the one or more memories, configured to:
receive a distribution request that is associated with a user account and an entity category;
identify a set of receiving entities associated with the entity category,
wherein individual entities of the receiving entities are approved to receive distributions associated with user accounts of the service provider;
determine, according to impact scores for the set of receiving entities, a ranking of the set of receiving entities according to respective information associated with individual entities of the set of receiving entities,
wherein the impact scores are indicative of levels of impact of respective entities within the entity category;
select, from the set of receiving entities and according to the ranking, a receiving entity from the set of receiving entities to receive the distribution as indicated in the distribution request; and
facilitate a transfer of the distribution from the user account to the receiving entity.

2. The system of claim 1, wherein the entity category is identified in the distribution request to indicate that one or more entities of the set of receiving entities are to receive the distribution without the distribution request specifically identifying the one or more entities.

3. The system of claim 1, wherein the transfer comprises a membership point transfer from a membership point balance associated with the user account.

4. The system of claim 1, wherein the distribution request identifies at least one of:
a type of the transfer,
a value of the distribution,
a quantity of receiving entities, or
a frequency associated with facilitating transfers of the distribution.

5. The system of claim 1, wherein the receiving entity is selected based on the ranking indicating that the receiving entity has a greatest impact, relative to the set of receiving entities, on a cause associated with the entity category.

6. The system of claim 1, wherein the ranking is determined based on receiving the distribution request.

7. The system of claim 1, wherein the one or more processors, prior to determining the ranking, are to:
receive, from an external information source, external information associated with the receiving entity,
wherein an impact score for the receiving entity is determined based on the external information that indicates a positive impact characteristic associated with the receiving entity contributing to a cause of the entity category.

8. A non-transitory computer-readable medium storing a set of instructions, the set of instructions comprising:
one or more instructions that, when executed by one or more processors of a device, cause the device to:
receive an approval request that is associated with an entity being authorized to receive distributions associated with user accounts of a service provider,
wherein the approval request includes internal information associated with the entity, and
wherein the approval request identifies an entity category associated with the entity;
receive, from an external information source, external information associated with the entity;
designate, based on processing the internal information and the external information, the entity to be approved as one of a set of receiving entities associated with the entity category,
wherein individual entities of the receiving entities are approved to receive the distributions;
determine, based on the internal information and the external information, an impact score associated with the entity being approved;
rank, based on the impact score, the entity within a ranking of the set of receiving entities; and
perform an action associated with facilitating a transfer of a distribution from a user account to the receiving entity based on the ranking.

9. The non-transitory computer-readable medium of claim 8, wherein the one or more instructions that cause the device to designate the entity as one of the set of receiving entities, cause the device to at least:
perform an authentication process to verify an identification of the entity that is indicated in the approval request, or
compare one or more parameters of the internal information with one or more corresponding parameters of the external information to validate the entity.

10. The non-transitory computer-readable medium of claim 8, wherein the internal information and the external information are processed using at least one of:
a natural language processing technique, or
a sentiment analysis technique.

11. The non-transitory computer-readable medium of claim 8, wherein the impact score is determined based on a weighted average of parameters identified in at least one of the internal information or the external information.

12. The non-transitory computer-readable medium of claim 8, wherein the impact score is indicative of a level of impact that the entity has had on a cause associated with the entity category, according to one or more parameters indicated in the external information and the internal information.

13. The non-transitory computer-readable medium of claim 8, wherein the one or more instructions further cause the device to:
receive additional external information associated with the entity; and
update the impact score based on the additional external information.

14. The non-transitory computer-readable medium of claim 8, wherein the one or more instructions, that cause the device to perform the action, cause the device to:
receive a distribution request associated with the user account,
wherein the distribution request specifies the entity category;
select, based on the ranking indicating that the entity is designated to receive the distribution, the entity to receive the distribution; and
facilitate the transfer of the distribution from the user account to the entity.

15. A method for managing a distribution associated with a service provider, comprising:
receiving, by a device, a point distribution request that is associated with a user account and an entity category;
identifying, by the device, a set of receiving entities associated with the entity category,
wherein individual entities of the receiving entities are approved to receive distributions associated with user accounts of the service provider;
selecting, by the device and according to a ranking of the set of receiving entities, a receiving entity from the set of receiving entities;
determining, by the device and from the point distribution request, that a distribution is designated for redemption with a particular type of merchant;
configuring, by the device, the distribution for redemption via the particular type of merchant to generate a restricted distribution; and
facilitating, by the device, a transfer of the restricted distribution from a point balance of the user account to a redemption balance of the receiving entity.

16. The method of claim 15, wherein the point distribution request does not specify that one or more of the receiving entities are to receive the restricted distribution.

17. The method of claim 15, wherein the point distribution request identifies at least one of:
a point value of the restricted distribution, or
a frequency associated with facilitating transfers of the restricted distribution.

18. The method of claim 15, wherein configuring the distribution for redemption via the particular type of merchant comprises:
appending a token to the distribution to form the restricted distribution,
wherein the token specifies a merchant identifier that is associated with the particular type of merchant and is configured to only allow a redemption of the restricted distribution that involves a merchant that is associated with the merchant identifier.

19. The method of claim 15, wherein the ranking indicates that individual receiving entities of the set of receiving entities are ranked according to corresponding impact scores,
wherein the corresponding impact scores are determined based on a weighted average of respective parameters associated with the set of receiving entities.

20. The method of claim 15, wherein facilitating the transfer of the restricted distribution comprises:
causing a transaction backend system associated with the service provider to reduce a point value identified in the point distribution request from the point balance of the user account; and
causing the transaction backend system to increase the redemption balance associated with an entity account of the receiving entity.
